(19) United States
(12) Patent Application Publication
(10) Pub. No.: US 2016/0016831 A1
(43) Pub. Date: Jan. 21, 2016

(54) TOP DOWN VARIABLE DEPTH AERATION SYSTEM

(71) Applicant: Robert Cecil Cooke, Wendell, NC (US)

(72) Inventor: Robert Cecil Cooke, Wendell, NC (US)

(21) Appl. No.: 14/334,266

(22) Filed: Jul. 17, 2014

(51) Int. Cl. C02F 1/74

(52) U.S. Cl. CPC C02F 1/74; C02F 2101/30

(57) ABSTRACT

The present invention relates to a system and method for the improved oxygenation of a body of water such as a pond or other water containing area. Water is pumped from below the surface to above the surface where it is oxygenated and then returned to below the surface. The location of the return is adjusted by mounting the system on an adjustable height frame, or made adjustable to the depth of the pump length of the water pipe.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates aeration of a body of water. In particular, it relates to a method of aeration of a body of water that is variable and aerates from the top down.

2. Description of Related Art

Dissolved Oxygen (DO) is a major contributor to water quality. Not only do fish and other aquatic animals need it, but oxygen breathing aerobic bacteria decompose organic matter. When oxygen concentrations become low, anoxic conditions may develop which can decrease the ability of the water body to support life.

Water aeration is the process of dissolving additional oxygen in a body of water, (i.e. increasing oxygen saturation). Water aeration is often required in water bodies that suffer from anoxic conditions, usually caused by adjacent human activities such as sewage discharges, agricultural run-off, poor water circulation, over-baiting a fishing lake or the like.

Accordingly, several methods have been developed to aerate bodies of water and these methods generally fall into two categories, surface and subsurface aeration. Aeration has been achieved through the infusion of air into the bottom of a lake, lagoon, pond or the like, while surface agitation from a fountain or spray-like device allows for oxygen exchange at the surface and the release of noxious gasses such as carbon dioxide, methane or hydrogen sulfide.

There are some aeration systems that attach aerators to a grid system of piping across a basin. The air is pressurized and discharged through the aerator, creating bubbles that are forced down into the water. Due to a bubble's natural inclination to rise, these types of systems are ineffective for depths greater than two or three feet.

Many aeration systems are installed more or less permanently to the bottom of the body of water. These are very difficult to service as they become fouled with scale or biosolids. At wastewater treatment plants, the bottom installed designs can incorporate some type of acid feed to pump acid through the aerators to clean them. However, the acid kills the beneficial bacteria that the aeration device is trying to respirate so these bacteria can break down the BOD load in the wastewater. The user may have to “reseed” with bacteria to resume the activated sludge treatment. The acid also has corrosive effects on the metal air pipes used to carry the compressed air to the aerators.

Another consideration is if you have 1 to 50 million gallons per day at a wastewater plant, there is no containment to store untreated water to allow the aeration system to be serviced. When the wastewater plants are being designed, the engineers greatly over-engineer the aeration system to allow for degradation. They may have 10 or 20 times the number of aerators than the amount actually needed so that the plant can function years into the future. The large number of aerators requires huge, very expensive blower systems to furnish compressed air to the aerators. All of the aerators must be functional and operated to help keep them open.

Aeration blowers account for 40% to 60% of a wastewater plants total energy consumption. The over-engineering is extremely costly over the life of the wastewater treatment plant. In addition, each blower system has to have a backup blower, in case the primary blower fails or needs service. Some plants have 4 to 6 blower systems just to function as backup systems, costing excessive amounts of money in the process.

There are many different surface aerators available. Pump aerators pump water into the air to transfer oxygen into the water. They offer only a small circle of aeration less than a foot deep around the immediate perimeter of the system. Venturi Systems incorporated a pump, and sometimes a propeller. They use the Venturi effect to draw in air from the atmosphere and inject it into the flow of water being pumped. These systems have limited capacities in terms of CFM (cubic feet per minute) delivered into the water and cannot aerate more than 3 or 4 feet deep because the Venturi generates very little air pressure. Paddle wheel devices turn at high speeds to aerate the water but offer no circulation and are not effective at depths over 2 or 3 feet. They are mostly used in fish ponds. In general, none of the systems create significant mixing of the water in the enclosure.

It is clear that there is still a need to provide efficient and cost effective aeration that overcomes the limitations and costs of the present methods of aerating a large body of water.

### BRIEF SUMMARY OF THE INVENTION

The present invention involves the discovery that a number of benefits not previously available in a water aeration system can be had by positioning an aerator injector above the surface of the water (an above surface system) and pumping water from beneath the surface up above the surface, past the injector and back down below the surface of the water.

With the injectors installed above the surface of the water, the aerated water is piped to any depth desired in an aeration basin, oxidation ditch, pond, or any other water containment for which aeration is beneficial. The aeration is scalable by the addition of more injectors and, where necessary, adding more pumps and down piping sections. The injectors in the present system are easily accessed for service in the event of fouling, grease or other biosolids.

The frame of the system is adjustable (e.g. has a telescoping frame that fits inside the base frame to allow support at the desired depth.) The down piping carrying the aerated water may be cut to size depending on the aeration depth required. (Bottom mounted bubble producing aerators require higher air pressure as the depth increases.) The present device actually adds air (aerates) to the water above the surface and pipes to the depth desired with no corresponding increase in air pressure.

The present system not only provides aeration but provides circulation of aerated water back into the basin, pond, ditch, etc. This is highly desirable for greater aeration efficiency.

In one embodiment of the present invention there is an aeration system for aerating a body of water having a top water surface comprising:
a) a water flow aeration piping system comprising
   i. a submersible water pump for positioning below the surface of the water;
   ii. a vertical water pipe having a bottom end in fluid communication with the water pump and a top end for positioning above the surface of the water;
   iii. a section of water pipe having a first and second end for positioning above the surface of the water; the first end in fluid communication with the top end of the vertical water pipe, the section of pipe having at least one injector for introducing oxygen into water flowing through the section of water pipe;
   iv. at least one injector water pipe section having a first end in fluid communication with the section of water pipe and a second end for positioning below the surface of the water in fluid communication with the body of water; and
   v. wherein when the water pump is operated in the body of water, water flows from the body of water, up the vertical pipe through the section of pipe past at least one of the injectors and down at least one injector water pipe and back to the body of water; and
b) a frame for positioning the system in the body of water wherein the water flow piping system is mounted on the frame for use in the body of water such that when the aerator system is positioned in the body of water while mounted on the frame, the second end of the injector water pipe is below the surface of the water, and that at least one injector is kept above the surface of the water.

### BRIEF DESCRIPTION OF THE DRAWINGS

FIG. 1 is an example of the aeration system of the present invention positioned in a body of water.

FIG. 2 is an example of the system supported on a flotation device.

FIG. 3 is the aeration system mounted on a wall using a wall bracket.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, (i.e., one or more methods, devices, or apparatuses for achieving the desired function) and that one skilled in the art could select from these or their equivalent in view of the disclosure herein and use of the term “means” is not intended to be limiting.

As used herein the term “aerating” refers to the increase in dissolved oxygen in a body of water such as a pond, lake, water filtration, water treatment and the like. In one embodiment, it refers to the process of introducing oxygen into the flowing stream of water by introducing the oxygen (or other desired gas or liquid in addition to oxygen) by means of flow introductions. For example, U.S. patent application Ser. Nos. 13/370,358 and 13/837,101, which are incorporated herein by reference, are suitable devices for introducing oxygen for the purposes of aeration. Oxygen can be in the form of pure oxygen, air or the like and can be obtained from the air, compressed and tanked, and also can contain carbon dioxide and other gases and liquids where desired.

As used herein the term “body of water” refers to any natural or artificial water containing area which can suffer from lack of dissolved oxygen or will benefit from additional dissolved oxygen. Water does not have to be the exclusive component of a body of water such as in a water treatment or sludge treatment facility, but that of lakes, ponds, holding tanks, basins, aquariums and the like.

As used herein the term “top water surface” refers to the water interface between the body of water and the atmosphere. One skilled in the art understands the top water surface and this is given its plain meaning.

As used herein the term “water flow aeration piping system” refers to a system of removing water from a body of water, aerating it along the top surface of the water and returning it to the body of water for the purpose of increasing the amount of dissolved oxygen in the body of water. The system also includes a circulation means for increasing the circulation of the oxygenated water within the body of water when it is returned.

As used herein the term “submersible water pump” refers to a powered pump for the purpose of placement under the top surface of a body of water and moving water under the top surface of the water to a different location. In general, water pumps are well known in the art. The submersible pumps will generally be placed toward the bottom of an aeration piping system for moving water in the body of water from where the pump is to the aeration system and then back down into the body of water (see e.g. the drawings for an example). In one embodiment of the present invention, the submersible pump has a pumping rate of 150 to 600 gpm (gallons per minute). However, one skilled in the art will choose a pump that matches the particular body of water being aerated; the amount of piping and various other factors obvious to one familiar with the teaching of the present invention.

As used herein the term “vertical water pipe” refers to a pipe suitable for use in water (e.g. plastic) that takes water from the submersible water pump and moves it from underneath the top surface of the body of water to above the top surface of the body of water. Note, that while connections are shown for each of the various sections, such junctions or connections can be anywhere along the system such that, for example, the vertical pipe might be in sections or there may be no particular means of disconnecting the particular sections right at their intersection points. The pipe can be adjusted in height by removing sections or cutting the pipe into the desired length.

As used herein the term “section of water pipe” refers to a part of the water flow aeration piping that is at least partially above the top surface of the body of water to allow positioning of an injector (described hereinafter) to be positioned above the top surface of the water. While the figures show a horizontal section, the piping could be angled partially under the surface, zig zag in shape, curved or other shapes, as long as the injector is above the surface of the water. The section of water pipe has a first end connected to the vertical pipe section and a second end attached to the injector section of the pipe.

As used herein the term “injector ” refers to a device for introducing oxygen and optionally carbon dioxide or other gases and liquids as the flow by the injector. In general, the injector is positioned above the surface of the body of water.

As used herein the term “injector water pipe” refers to a part of the system, such devices are well known in the art where the water pumped through the system by the submersible pump is returned to the body of water. In the practice of the invention, the injector water pipe is made of water compatible material, the first end is in fluid communication with the section of water pipe after the water has been oxygenated wherein the second end is positioned beneath the surface of the water to return oxygenated water to the body of water. Since the pump is pumping the water through the system, the water returns to the body of water at some speed, thus creating circulation at the point of entry to the body of water. In one embodiment, a nozzle which narrows the diameter of the pipe is placed on the second end thus increasing the speed and force of water entering the body of water and increasing the mixing effect. The depth of the pump and returning water is positioned where desired, but in one embodiment near or at the bottom of the body of water.

As used herein the term “height adjustable frame” refers to a frame for mounting the water flow aeration piping system during use, wherein the second end of the injector water pipe is kept below the surface of the body of water and the injector is kept above the surface of the body of water. The height adjustable frame allows adjusting the depth of the second end of the injector water pipe so that aerated water can be delivered at varying depths. In one embodiment, the frame is telescoping vertically allowing adjustment of the depth of the injected water. The frame can be mounted on a fixed surface (e.g. a wall or the like or any other desired surface); it can be adjustable or non-adjustable. In one embodiment, the frame and system 15 are mounted on a frame that is a flotation device for mounting any place desired. On the surface of the water a flotation device can be anything that floats and will support the device in water. Examples are, but not limited to, inflatable devices, Styrofoam or other floating material, a boat and the like.

As used herein the term “pipe” refers to pipe for transporting water in the system.

Therefore any pipe useful for carrying a water supply (and anything else in the water) can be utilized such as plastic piping (tubing), stainless steel pipeline and the like. One skilled in the art can select the proper piping for the particular body of water the system is being used in. Sections of connected pipe can be permanent connections or removable, with one large piece of piping or multiple sections as desired. In order to remove and replace an injector, the injector can be removable (such as by screwing together) from the piping and/or a section of the piping with the injector can be removed and replaced (an embodiment shown in the figure).

In use, the aeration system is positioned in place with the injector above the surface of the body of water, and the injector and submersible pump positioned below the surface of the body of water. The pump is engaged and water is removed from the body of water up through the vertical pipe to the section of pipe having one or more injectors thus oxygenating the water. The water passes from there to the injector water pipe section for returning the oxygenated water back to the body of water oxygenated. If a nozzle and/or sufficient speed of the returned water is utilized, a current is established, which increases the mixing and distribution of oxygenated water throughout the body of water.

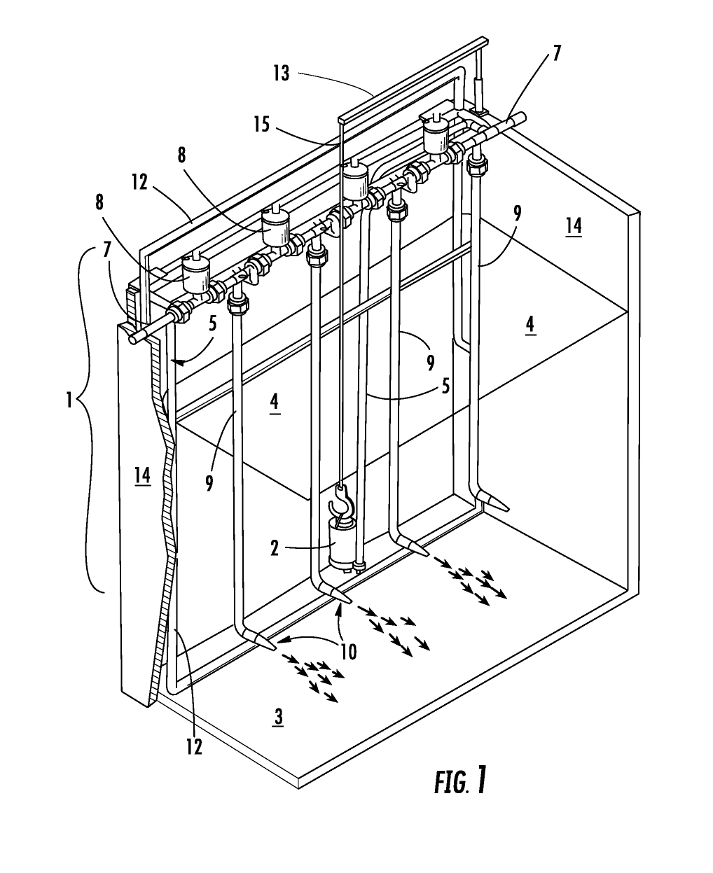

Now referring to the drawings, FIG. 1 is an embodiment of the aeration system of the present invention. The system 1 consists of a water flow system comprising a submersible water pump 2 which pumps water from the body of water 3 having a top water surface 4. A vertical water pipe 5, that is optionally height adjustable, having a bottom end in fluid communication with water pump 2 which removes water from the body of water 3 and moves it out of the body of water to a position over the top surface 4 of body of water 3 where it delivers it to the section of water pipe 7, a portion of which is above the surface of the body of water 4. There it travels to section 7 encountering injectors 8, that are optionally height adjustable, which introduce oxygen into the flowing water before returning to injector water pipe sections 9 before returning the oxygenated water via injector nozzle 10 which creates an oxygenated water flow indicated by the multiple arrows which aids in mixing the oxygenated water with the non-oxygenated water. The water flow system is mounted on a frame 12. Optionally, the frame is height adjustable. A jib crane 13 with steel cable 15 (optional) is shown for height adjustment. In the present view, the system has a distance of 24 feet from the injectors to the injector nozzles 10. In this embodiment, the frame 12 is mounted on wall 14 for support. Height can also be adjusted by adjusting height of vertical water pipe 5 and injector pipe sections as well as by adjusting the length of the pipes.

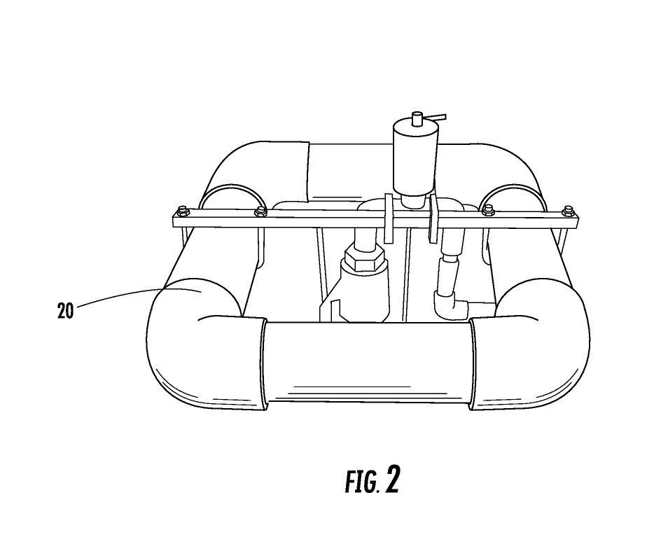

FIG. 2 shows a portion of a water flow system mounted on a rectangular inflatable device 20 which floats on the top surface of the body of water, instead of on a wall as in FIG. 1. The whole system can be adjustably moved in to position in the body of water, unlike the system shown in the previous figure. While the exact position can move, that can be an advantage in certain circumstances where different locations are desired over time.

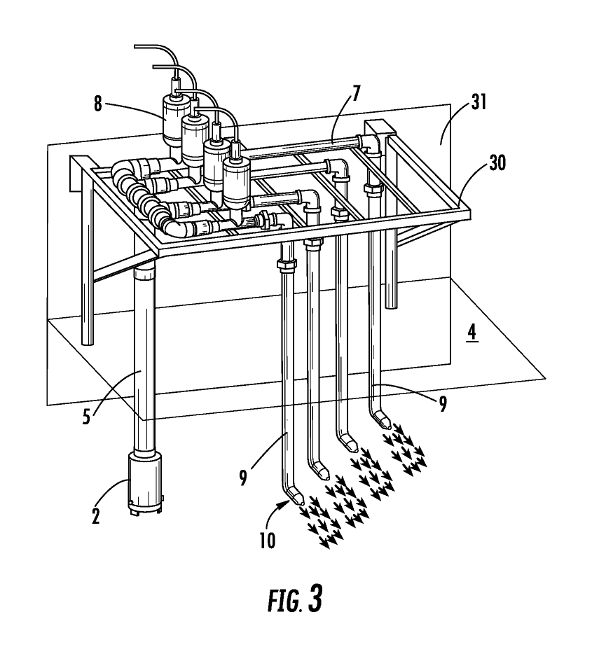

FIG. 3 is a different layout for a system of the present invention. The system is mounted on frame 30 which is mounted on wall 31.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like, apparent to those skilled in the art, still fall within the scope of the invention as claimed by the Applicant.

What is claimed is:

1. An aeration system for aerating a body of water having a top water surface comprising:
a) a water flow aeration piping system comprising
i. a submersible water pump for positioning below the surface of the water;
ii. a vertical water pipe having a bottom end in fluid communication with the water pump and a top end for positioning above the surface of the water;
iii. a section of water pipe having a first and second end for positioning above the surface of the water; the first end in fluid communication with the top end of the vertical water pipe, the section of pipe having at least one injector for introducing oxygen into water flowing through the section of water pipe;
iv. at least one injector water pipe section having a first end in fluid communication with the section of water pipe and a second end for positioning below the surface of the water in fluid communication with the body of water; and
v. wherein when the water pump is operated in the body of water, water flows from the body of water, up the vertical pipe through the section of pipe past at least one of the injectors and down at least one injector water pipe and back to the body of water; and
b) a frame for positioning the system in the body of water wherein the water flow piping system is mounted on the frame for use in the body of water such that when the aerator system is positioned in the body of water while mounted on the frame, the second end of the injector water pipe is below the surface of the water, and that at least one injector is kept above the surface of the water.

2. The aerator system according to claim 1 wherein the second end of the at least one injector water pipe is fitted with a jet nozzle.

3. The aerator system according to claim 1 wherein the water pump has an output of from about 150 to about 600 gpm.

4. The aerator system according to claim 1 wherein the frame is adjustable to adjust to the depth of at least one of the water pump and the at least one injector.

5. The aerator system according to claim 4 wherein the frame is adjusted in the depth of the second end of the injector water pipe by use of a jib crane.

6. The aerator system according to claim 4 wherein the frame is telescoping in height.

7. The aerator system according to claim 1 wherein the frame is a flotation device.

8. The aerator system according to claim 1 wherein the frame is a wall mounted frame.

9. The aerator system according to claim 1 wherein at least one of the vertical pipe and injector water pipe is adjustable in length.

10. The aerator system according to claim 1 wherein the system is positioned in the body of water.

11. The aerator system according to claim 10 wherein at least one of the water pumps and at least one second end of the injector water pipe is positioned toward the bottom of the body of water.

12. The aerator system according to claim 1 wherein there are a plurality of aeration injectors.

13. The aerator system according to claim 1 wherein pipe sections are removably connected.

14. The aerator system according to claim 1 wherein the at least one injector is removably connected.

15. The aerator system according to claim 1 wherein the injector is capable of injecting a gas or liquid into water flowing in the system other than oxygen.

16. A method of aerating a body of water having a top water surface using a piping system comprising:
a) selecting a piping system mounted on a frame;
b) pumping water through the piping system using a submersible pump from a position below the top surface of the body of water to above the surface of the body of water;
c) oxygenating the water in the piping system while it is above the surface of the body of water; and
d) returning the water in the piping system to below the top surface of the body of water by a return pipe wherein the depth of the return pipe is determined by adjustment of at least one of the length of the frame, the depth of the submersible pump, and the length of the return pipe.

17. The method according to claim 16 wherein the pump is pumping water at a rate of between about 150 and 600 gpm.

18. The method according to claim 16 wherein the depth is adjusted a plurality of times.

19. The method according to claim 16 wherein the water is oxygenated with an injector.

20. The method according to claim 19 which further comprises replacing the injector while it is above the surface of the body of water.

21. The method according to claim 16 wherein the frame is on a floatation device and the system allowed to float freely in the body of water.

22. The method according to claim 16 wherein the piping system and frame are mounted on a fixed object so it remains in a fixed position in the body of water.
